(19) United States
(12) Patent Application Publication
(10) Pub. No.: US 2024/0318269 A1
(43) Pub. Date: Sep. 26, 2024

(54) HOT METAL TEMPERATURE PREDICTION METHOD, OPERATION GUIDANCE METHOD, METHOD OF MANUFACTURING HOT METAL, HOT METAL TEMPERATURE PREDICTION APPARATUS, OPERATION GUIDANCE APPARATUS, BLAST FURNACE OPERATION GUIDANCE SYSTEM, BLAST FURNACE OPERATION GUIDANCE SERVER, AND TERMINAL APPARATUS

(71) Applicant: JFE STEEL CORPORATION, Chiyoda-ku, Tokyo (JP)

(72) Inventors: Yoshinari HASHIMOTO, Chiyoda-ku, Tokyo (JP); Ryosuke MASUDA, Chiyoda-ku, Tokyo (JP)

(73) Assignee: JFE STEEL CORPORATION, Chiyoda-ku, Tokyo (JP)

(21) Appl. No.: 18/578,006

(22) PCT Filed: Jul. 15, 2022
(86) PCT No.: PCT/JP2022/027934

§ 371 Date: Jan. 10, 2024

(30) Foreign Application Priority Data
Jul. 27, 2021 (JP) 2021-122756

(51) Int. Cl. C21B 7/24

(52) U.S. Cl. CPC C21B 7/24

(57) ABSTRACT

A hot metal temperature prediction method includes a reaction amount calculation step (S1) of calculating a reaction amount inside a blast furnace using a physical model that takes into account reactions and heat transfer phenomena inside the blast furnace, a deviation calculation step (S2) of calculating a deviation between the reaction amount calculated using the physical model and a measured reaction amount, a model parameter adjustment step (S3) of adjusting a parameter of the physical model that causes drift in a gas inside the blast furnace, so that the calculated deviation is reduced, and a hot metal temperature prediction step (S4) of predicting a future hot metal temperature using the physical model for which the parameter was adjusted.

### TECHNICAL FIELD

The present disclosure relates to a hot metal temperature prediction method, an operation guidance method, a method of manufacturing hot metal, a hot metal temperature prediction apparatus, an operation guidance apparatus, a blast furnace operation guidance system, a blast furnace operation guidance server, and a terminal apparatus.

### BACKGROUND

The number of skilled operators is decreasing in the steelmaking industry, making it increasingly difficult to continue stable blast furnace operation. Hot metal temperature control is important for maintaining stable blast furnace operation. As the hot metal temperature decreases, slag becomes more viscous and difficult to discharge, which can reduce the productivity of the blast furnace. If the hot metal temperature drops excessively, the hot metal and slag will solidify and cannot be discharged. This may lead to a furnace cooling accident in which operation of the blast furnace stops. Many methods for predicting the hot metal temperature have been proposed. See, for example, Patent Literature (PTL) 1 and PTL 2.

### CITATION LIST

### Patent Literature

PTL 1: JP 6531782 B2
PTL 2: JP 6024718 B2

### SUMMARY

### Technical Problem

There are various mechanisms by which furnace cooling accidents occur, but in a typical case, the airflow resistance increases during charging of fine-grained material or when the liquid level of slag rises, resulting in a non-uniform gas flow inside the furnace. Non-uniform gas flow in the furnace is thought to worsen the contact between the sintered ore and CO gas, causing a direct reduction reaction accompanied by heat absorption in the lower part of the furnace, which leads to a decrease in the hot metal temperature.

Conventional physical models of furnace conditions for hot metal temperature prediction calculate the gas flow by assuming a packed layer with small variation in the void ratio. Conventional physical models have difficulty in reproducing the aforementioned decrease in hot metal temperature caused by gas drift (non-uniformity of gas flow inside the furnace).

It could be helpful to provide a hot metal temperature prediction method and a hot metal temperature prediction apparatus that can predict the hot metal temperature with high accuracy. It could also be helpful to provide an operation guidance method, a method of manufacturing hot metal, an operation guidance apparatus, a blast furnace operation guidance system, a blast furnace operation guidance server, and a terminal apparatus that provide guidance for the operation of a blast furnace based on a highly accurately predicted hot metal temperature.

### Solution to Problem

A hot metal temperature prediction method according to an embodiment of the present disclosure includes:
calculating a reaction amount inside a blast furnace using a physical model that takes into account reactions and heat transfer phenomena inside the blast furnace;
calculating a deviation between the reaction amount calculated using the physical model and a measured reaction amount;
adjusting a parameter of the physical model that causes drift in a gas inside the blast furnace, so that the calculated deviation is reduced; and
predicting a future hot metal temperature using the physical model for which the parameter was adjusted.

An operation guidance method according to an embodiment of the present disclosure includes:
presenting an operation action to increase the hot metal temperature based on the hot metal temperature predicted by the aforementioned hot metal temperature prediction method.

A method of manufacturing hot metal according to an embodiment of the present disclosure includes:
manufacturing hot metal in accordance with the operation action presented by the aforementioned operation guidance method.

A hot metal temperature prediction apparatus according to an embodiment of the present disclosure includes:
a memory configured to store a physical model that takes into account reactions and heat transfer phenomena inside a blast furnace;
a reaction amount calculator configured to calculate a reaction amount inside the blast furnace using the physical model;
a deviation calculator configured to calculate a deviation between the reaction amount calculated using the physical model and a measured reaction amount;
a model parameter adjuster configured to adjust a parameter of the physical model that causes drift in a gas inside the blast furnace, so that the calculated deviation is reduced; and
a hot metal temperature predictor configured to predict a future hot metal temperature using the physical model for which the parameter was adjusted.

An operation guidance apparatus according to an embodiment of the present disclosure includes:
an operation action presentation interface configured to present an operation action to increase the hot metal temperature based on the hot metal temperature predicted by the aforementioned hot metal temperature prediction apparatus.

A blast furnace operation guidance system according to an embodiment of the present disclosure includes:
a blast furnace operation guidance server and a terminal apparatus, wherein
the blast furnace operation guidance server includes
   a measured value acquisition interface configured to acquire a measured value indicating an operation state of a blast furnace,
   a memory configured to store a physical model that takes into account reactions and heat transfer phenomena inside the blast furnace,
   a reaction amount calculator configured to calculate a reaction amount inside the blast furnace using the physical model,
   a deviation calculator configured to calculate a deviation between the reaction amount calculated using the physical model and a measured reaction amount,
   a model parameter adjuster configured to adjust a parameter of the physical model that causes drift in a gas inside the blast furnace, so that the calculated deviation is reduced,
   a hot metal temperature predictor configured to predict a future hot metal temperature using the physical model for which the parameter was adjusted, and
   an operation action presentation interface configured to present an operation action to increase the hot metal temperature based on the predicted hot metal temperature, and
the terminal apparatus includes
   an operation action acquisition interface configured to acquire the operation action presented by the blast furnace operation guidance server, and
   a display configured to display the acquired operation action.

A blast furnace operation guidance server according to an embodiment of the present disclosure includes:
a measured value acquisition interface configured to acquire a measured value indicating an operation state of a blast furnace;
a memory configured to store a physical model that takes into account reactions and heat transfer phenomena inside the blast furnace;
a reaction amount calculator configured to calculate a reaction amount inside the blast furnace using the physical model;
a deviation calculator configured to calculate a deviation between the reaction amount calculated using the physical model and a measured reaction amount;
a model parameter adjuster configured to adjust a parameter of the physical model that causes drift in a gas inside the blast furnace, so that the calculated deviation is reduced;
a hot metal temperature predictor configured to predict a future hot metal temperature using the physical model for which the parameter was adjusted; and
an operation action presentation interface configured to present an operation action to increase the hot metal temperature based on the predicted hot metal temperature.

A terminal apparatus according to an embodiment of the present disclosure is a terminal apparatus forming part of a blast furnace operation guidance system together with a blast furnace operation guidance server, the terminal apparatus including:
an operation action acquisition interface configured to acquire an operation action presented by the blast furnace operation guidance server; and
a display configured to display the acquired operation action, wherein
the blast furnace operation guidance server is configured to adjust a parameter, of a physical model that takes into account reactions and heat transfer phenomena inside a blast furnace, that causes drift in a gas inside the blast furnace, so that a deviation between a reaction amount inside the blast furnace calculated using the physical model and a measured reaction amount is reduced, and
the operation action is an operation action to increase a hot metal temperature based on a future hot metal temperature predicted using the physical model for which the parameter was adjusted.

### Advantageous Effect

According to the present disclosure, a hot metal temperature prediction method and a hot metal temperature prediction apparatus that can predict the hot metal temperature with high accuracy can be provided. According to the present disclosure, an operation guidance method, a method of manufacturing hot metal, an operation guidance apparatus, a blast furnace operation guidance system, a blast furnace operation guidance server, and a terminal apparatus that provide guidance for the operation of a blast furnace based on a hot metal temperature predicted to a high degree of accuracy can also be provided.

### BRIEF DESCRIPTION OF THE DRAWINGS

In the accompanying drawings:

FIG. 1 is a diagram illustrating input/output information of a physical model used in the present disclosure;

FIG. 2 is a diagram illustrating an example of future predictions of hot metal temperature;

FIG. 3 is a diagram illustrating predictions by the physical model without considering drift;

FIG. 4 is a diagram illustrating predictions by the physical model while considering drift;

FIG. 5 is a diagram illustrating the result of calculating the furnace temperature distribution;

FIG. 6 is a diagram illustrating example configurations of a hot metal temperature prediction apparatus and an operation guidance apparatus according to an embodiment;

FIG. 7 is a flowchart illustrating a hot metal temperature prediction method according to an embodiment;

FIG. 8 is a flowchart illustrating an operation guidance method according to an embodiment; and

FIG. 9 is a diagram illustrating an example configuration of a blast furnace operation guidance system according to an embodiment.

### DETAILED DESCRIPTION

The hot metal temperature prediction method, operation guidance method, method of manufacturing hot metal, hot metal temperature prediction apparatus, operation guidance apparatus, blast furnace operation guidance system, blast furnace operation guidance server, and terminal apparatus according to embodiments of the present disclosure are described below with reference to the drawings. The physical model used in the present disclosure is a physical model (non-steady model) that can calculate the internal (in-furnace) state of a blast furnace in a non-steady state and is configured by a partial differential equation set that takes into account physical phenomena such as ore reduction, heat exchange between ore and coke, and melting of ore, like the method described in Reference 1 (K. Takatani et al., ISIJ International, Vol. 39 (1999), p. 15). The non-steady state includes, for example, the occurrence of events such as blowouts or hanging.

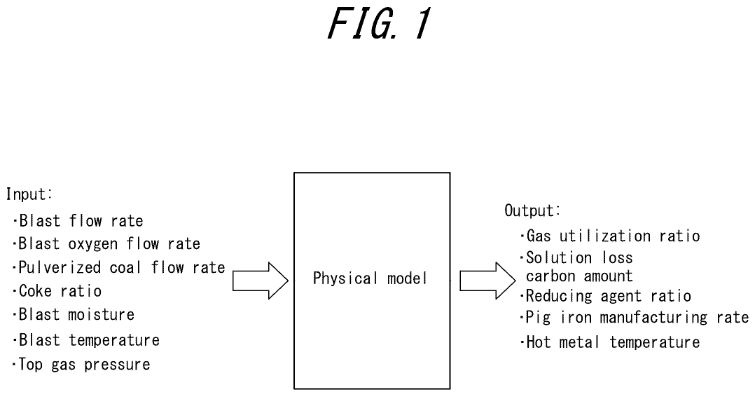

As illustrated in FIG. 1, the main variables that vary with time among input variables provided to the physical model are the blast flow rate, blast oxygen flow rate, pulverized coal flow rate, coke ratio, blast moisture, blast temperature, and top gas pressure. These input variables are the operating variables or operating factors of the blast furnace. The blast flow rate, blast oxygen flow rate, and pulverized coal flow rate are respectively the flow rates of air, oxygen, and pulverized coal delivered to the blast furnace. The coke ratio is the coke ratio at the top of the furnace and is the weight of coke used per ton of hot metal produced. The blast moisture is the humidity of the air delivered to the blast furnace. The blast temperature is the temperature of the air delivered to the blast furnace. The top gas pressure is the pressure of the gas at the top of the furnace.

The main output variables of the physical model are the gas utilization ratio, the solution loss carbon amount, the reducing agent ratio, the pig iron manufacturing rate, and the hot metal temperature. The hot metal temperature and the pig iron manufacturing rate, which change from moment to moment, can be calculated using the physical model. The time interval for this calculation is not particularly limited but is 30 minutes in the present embodiment. The time difference between “t+1” and “t” in the equations of the physical model described below is 30 minutes in the present embodiment. In the present embodiment, the physical model is a three-dimensional non-steady model that can estimate the three-dimensional temperature distribution inside the furnace, the ore reduction rate distribution, and the like. However, the form of the physical model is not limited to a three-dimensional non-steady model.

The physical model can be expressed by the following equation.

$$x ( t + 1 ) = f ( x ( t ) , u ( t ) ) \qquad ( 1 )$$

$$y ( t ) = C ( x ( f ) ) \qquad ( 2 )$$

Here, x(t) is a state variable calculated within the physical model. The state variables are, for example, the temperature of the coke, the temperature of the iron, the oxidation degree of the ore, and the rate of descent of the raw material. The variable y(t) is the hot metal temperature (HMT), which is the control variable. The variable u(t) is the aforementioned input variable and can be manipulated by the operator performing an operation on the blast furnace. That is, the input variables are the blast flow rate BV(t), the blast oxygen flow rate BVO(t), the pulverized coal flow rate PCI(t), the coke ratio CR(t), the blast moisture BM(t), the blast temperature BT(t), and the top gas pressure TGP(t) and can be expressed as u(t)=(BV(t), BVO(t), PCI(t), CR(t), BM(t), BT(t), TGP(t)).

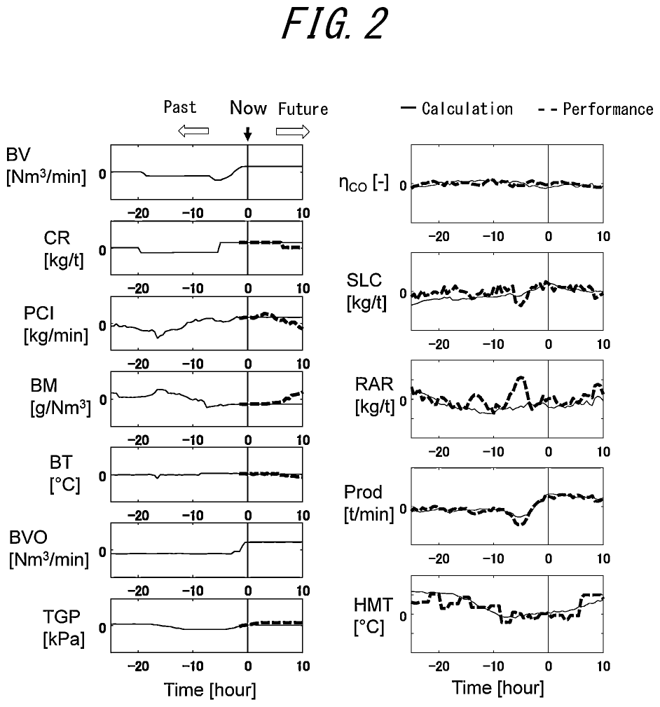

Here, future hot metal temperatures can be predicted by iterative calculations using Equations (1) and (2), assuming that the input variables at the present time hold in the future. FIG. 2 illustrates the results of such iterative calculations to predict future hot metal temperatures. The horizontal axis in FIG. 2 is the time axis. The units are hours. Negative values indicate past time. The graphs of input variables on the left side of FIG. 2 use the aforementioned symbols. Graphs of the output variables of the physical model are located on the right side of FIG. 2. The variable η_{CO} is the gas utilization ratio. SLC is the solution loss carbon amount. RAR is the reducing agent ratio. Prod is the pig iron manufacturing rate. HMT is the hot metal temperature, as described above.

In the example in FIG. 2, there was an increase in the coke ratio (CR) from 5 hours before the current time and a decrease in blast moisture (BM) from 15 hours to 8 hours before the current time. These effects are predicted to increase the future hot metal temperature (HMT). When the subsequent actual performance (values actually measured at the actual blast furnace) was plotted in overlap, the upward trend was consistent with the prediction. Sufficiently good prediction accuracy is achieved unless there are non-steady conditions such as furnace cooling, as examined below.

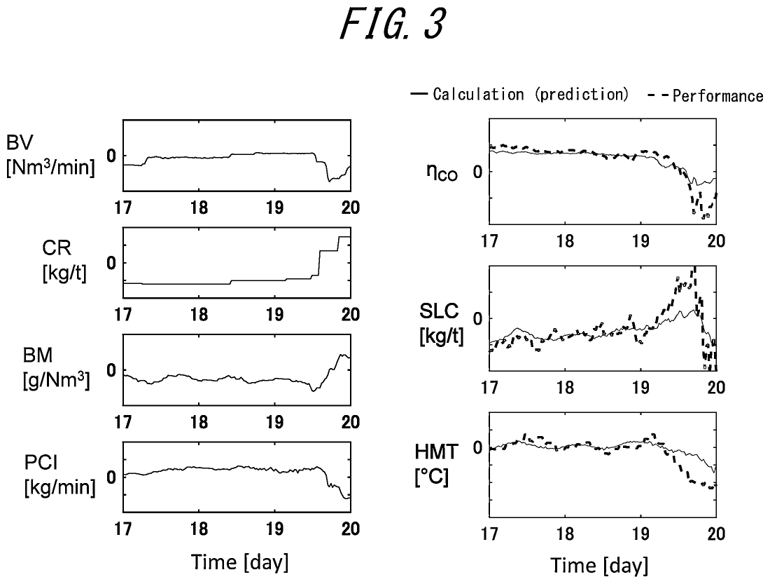

FIG. 3 illustrates the prediction results with the aforementioned method using input variables for the case of further furnace cooling. In FIG. 3, the period indicated by the horizontal axis (time axis) is longer than in FIG. 2, and the units are days. In typical cases in which furnace cooling occurs, the gas flow inside the furnace is non-uniform. If the gas flow in the furnace is biased toward a particular bearing, the contact between iron oxide and CO and H₂ gases deteriorates, resulting in delayed reduction of iron oxide. In the example in FIG. 3, the gas utilization ratio (η_{CO}) decreases after 19.5 days, and the solution loss carbon amount (SLC) increases after 19.2 days. The physical model calculations indicated by the solid lines do not predict such events. In the example in FIG. 3, the hot metal temperature (HMT) was predicted 8 hours beforehand by the aforementioned iterative calculations, but a large deviation occurred from the plotted performance values. In other words, a conventional method cannot represent gas drift in the physical model, and a large deviation between predicted and performance values (measured values) occurs in a case in which furnace cooling occurs.

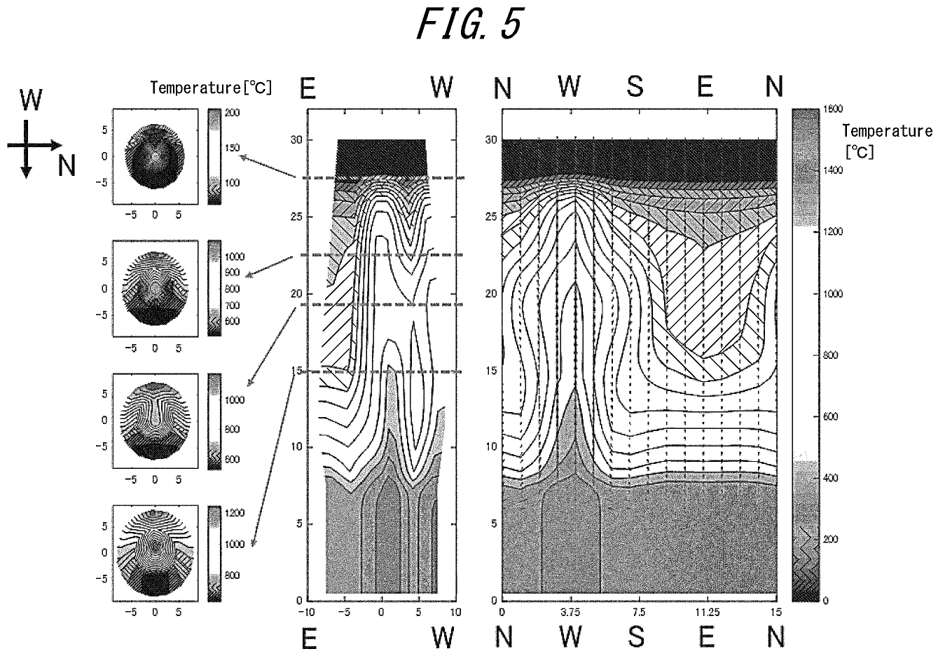

Therefore, as a new method, a parameter related to gas flow in the physical model was adjusted for the value of the reaction amount (gas utilization ratio, solution loss carbon amount, and the like) inside the furnace to match the measured value even in a case in which furnace cooling occurs. Specifically, gas drift inside the furnace was generated by adjusting (for example, increasing) the void ratio in a particular region within the packed layer inside the furnace as such a parameter. The particular region may be a particular orientation, for example, in a case in which positions in the packed layer are associated with bearings (see FIG. 5).

Here, the airflow resistance, which governs the gas flow in the packed layer, is greatly affected by the particle size and void ratio of the raw material. It is difficult, however, to directly measure the grain size and void ratio inside the furnace in real time. In the present embodiment, only the void ratio was adjusted as a parameter related to gas flow. Instead of or together with the void ratio, the grain size may be the parameter to be adjusted. In other words, the parameter to be adjusted as a parameter related to gas flow may be at least one of void ratio and grain size in a particular region within the packed layer inside the furnace.

The procedure for changing the void ratio in the present embodiment is as follows. The degree of dissociation between the measured reaction amount, such as the solution loss carbon amount (SLC), at a certain time step t and the calculated value (predicted value) calculated using the physical model is calculated. Next, the void ratio of the packed layer in the particular region is updated at each time step as indicated in the Equation (3) below, so that the dissociation between the measured value and the calculated value of the reaction amount is reduced.

$$ε ( t + 1 ) = ε ( t ) + ( S L {C}_{a c t} ( t ) - S L {C}_{c a . l} ( t ) ) \qquad ( i )$$

Here, & is the void ratio. SLC_{act} is the measured value of the solution loss carbon amount. SLC_{cal} is the calculated value of the solution loss carbon amount. In Equation (3), the degree of dissociation is obtained by subtracting the calculated value from the measured value. In the present embodiment, the solution loss carbon amount, which significantly affects the amount of heat absorption, was used as the reaction amount, but as another example, the reaction amount may be the gas utilization ratio. In other words, the reaction amount may include at least one of the solution loss carbon amount and the gas utilization ratio. The reaction amount may include the pig iron manufacturing rate or the like.

In the present embodiment, the void ratio was varied for only one mesh among the eight meshes classified in the circumferential direction of the 3D model. At this time, the void ratio was allowed to vary over the entire region with respect to the height direction. For the radial direction, the void ratio was varied only in the mesh area close to the wall.

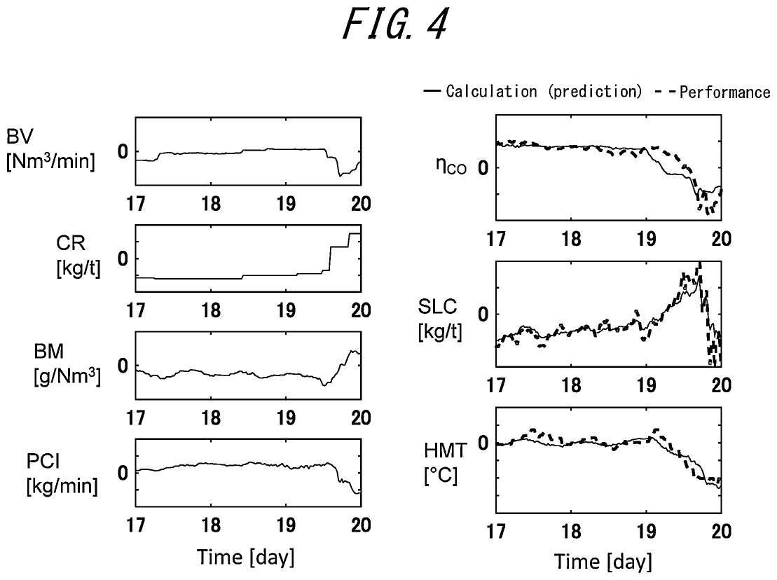

FIG. 4 illustrates the results of the same predictions as in FIG. 3, with the gas drift inside the furnace thus generated within the physical model. It is clear from a comparison with FIG. 3 that the accuracy of the predictions improved. As illustrated in FIG. 4, an increase in the solution loss carbon amount (SLC) and a decrease in the hot metal temperature (HMT), for example, are predicted with good accuracy.

FIG. 5 illustrates the results of the furnace temperature distribution and gas flow at 19.5 days in FIG. 4. In this example, the position in the packed layer is associated with bearings (East (E), South (S), West (W) and North (N)). The vertical direction indicates the height direction of the blast furnace. In the example in FIG. 5, the gas flow is biased toward a specific bearing (specifically, west (W)), and the temperature is higher in that direction. It it also clear that the temperature decreases on the opposite side (specifically, east (E)) from the bearing where the drift occurred. Such bias in temperature distribution can be verified by, for example, comparing the detected values of temperature sensors installed at a plurality of locations inside the furnace.

Here, some parameters of the physical model (gas reduction equilibrium parameters for iron ore) are also adjusted with the technology in PTL 1. However, the technology in PTL 1 assumes that the circumferential distribution of gas flow inside the furnace is uniform. The method of the present embodiment is effective in a case in which the circumferential distribution of gas flow is determined to be non-uniform based on information from, for example, a furnace top gas sonde.

The hot metal temperature prediction apparatus according to the present embodiment (see below for details) adjusts a parameter of the physical model that causes drift in a gas inside the furnace, so that the aforementioned deviation is reduced. The hot metal temperature can be predicted to a high degree of accuracy by predicting the future hot metal temperature using the physical model for which the parameter was adjusted.

The operation guidance apparatus according to the present embodiment (see below for details) can present an operation action to increase the hot metal temperature as guidance in a case in which the predicted hot metal temperature is equal to or less than a threshold. Operation actions include, for example, increasing the coke ratio. The operation guidance apparatus can avoid operational problems (such as loss of productivity or furnace cooling accidents) by presenting appropriate operation actions to the operator.

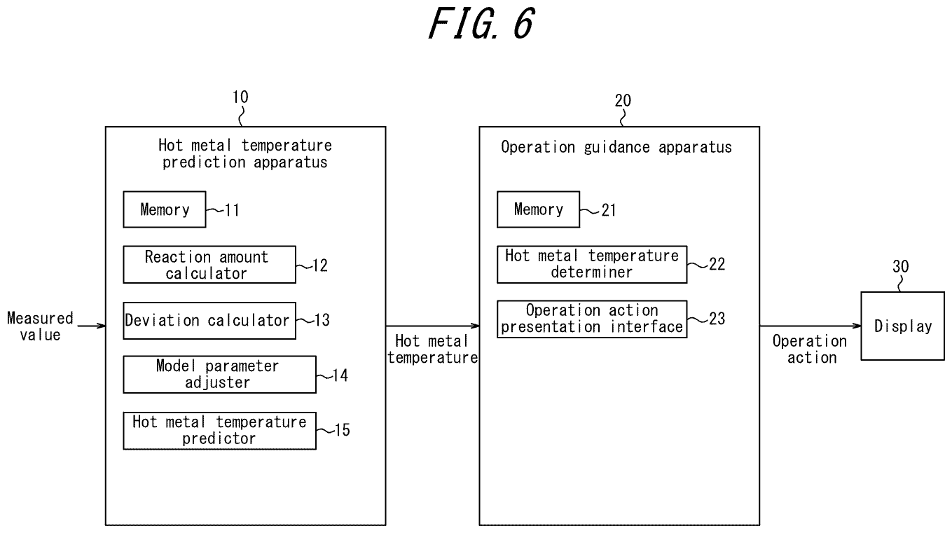

FIG. 6 is a diagram illustrating example configurations of a hot metal temperature prediction apparatus 10 and an operation guidance apparatus 20 according to an embodiment. As illustrated in FIG. 6, the hot metal temperature prediction apparatus 10 includes a memory 11, a reaction amount calculator 12, a deviation calculator 13, a model parameter adjuster 14, and a hot metal temperature predictor 15. The operation guidance apparatus 20 includes a memory 21, a hot metal temperature determiner 22, and an operation action presentation interface 23. The hot metal temperature prediction apparatus 10 acquires performance values (also referred to as measured values), which are various measurements indicating the operation state of the blast furnace, from sensors and the like installed in the blast furnace, and performs calculations using the aforementioned physical model. The operation guidance apparatus 20 acquires the hot metal temperature calculated by the hot metal temperature prediction apparatus 10 and displays the operation action on a display 30 as guidance for operation of the blast furnace. The operation guidance apparatus 20 displays the operation action on the display 30 as guidance to increase the hot metal temperature in a case in which the predicted hot metal temperature is equal to or less than a threshold (for example, 1500° C.). The display 30 may be a display apparatus such as a liquid crystal display (LCD) or an organic electro-luminescent (EL) panel.

First, the components of the hot metal temperature prediction apparatus 10 are described. The memory 11 stores a physical model that takes into account reactions and heat transfer phenomena inside a blast furnace. The memory 11 also stores programs and data related to hot metal temperature prediction. The memory 11 may include any memory device, such as semiconductor memory devices, optical memory devices, and magnetic memory devices. Semiconductor memory devices may, for example, include semiconductor memories. The memory 11 may include a plurality of types of memory devices.

The reaction amount calculator 12 calculates a reaction amount inside the blast furnace using the physical model. In the present embodiment, the reaction amount includes at least one of the solution loss carbon amount and the gas utilization ratio.

The deviation calculator 13 calculates a deviation between the reaction amount calculated using the physical model and a measured reaction amount. In the present embodiment, the deviation is obtained by subtracting the calculated value from the measured value.

The model parameter adjuster 14 adjusts a parameter, among the parameters of the physical model, that causes drift in a gas inside the blast furnace, so that the calculated deviation is reduced. In the present embodiment, the parameter to be adjusted is the void ratio in a specific region within the packed layer inside the furnace. However, instead of or together with the void ratio, the grain size may be used.

The hot metal temperature predictor 15 predicts a future hot metal temperature using the physical model for which the parameter was adjusted. Prediction of the hot metal temperature is accomplished by iterative calculations using the above Equations (1) and (2). The predicted hot metal temperature is outputted to the operation guidance apparatus 20.

Next, the components of the operation guidance apparatus 20 are described. The memory 21 stores programs and data related to operation guidance. The memory 21 may include any memory device, such as semiconductor memory devices, optical memory devices, and magnetic memory devices. Semiconductor memory devices may, for example, include semiconductor memories. The memory 21 may include a plurality of types of memory devices.

The hot metal temperature determiner 22 determines whether the hot metal temperature predicted by the hot metal temperature prediction apparatus 10 is equal to or less than a threshold. In a case in which the temperature is equal to or less than the threshold, the hot metal temperature determiner 22 causes the operation action presentation interface 23 to present an operation action.

The operation action presentation interface 23 presents an operation action to increase the hot metal temperature. The operation action presentation interface 23 may, for example, display a 10% increase in the coke ratio as the operation action on the display 30. Here, the operation action presentation interface 23 may have the hot metal temperature prediction apparatus 10 calculate an appropriate value for the coke ratio or the like. In other words, the operation action presentation interface 23 may have the hot metal temperature prediction apparatus 10 perform a simulation using the physical model to determine the operation action to be presented.

The operator may change the operating conditions of the blast furnace machine based on the operation action displayed on the display 30. Such operation guidance for the blast furnace can be implemented as part of a method of manufacturing hot metal. Furthermore, the computer that manages the manufacturing of hot metal may automatically change the conditions for the manufacturing of hot metal according to the operation action presented by the operation guidance apparatus 20.

Here, the hot metal temperature prediction apparatus 10 and the operation guidance apparatus 20 may be separate apparatuses or integrated into one apparatus. In the case of an integrated apparatus, the memory 11 and the memory 21 may be realized by the same memory device.

The hot metal temperature prediction apparatus 10 and the operation guidance apparatus 20 may be realized by a computer, such as a process computer that controls the operation of a blast furnace or the manufacturing of hot metal, for example. The computer includes, for example, a memory and hard disk drive (memory device), a CPU (processing unit), and a display device such as a display. An operating system (OS) and application programs for carrying out various processes can be stored on the hard disk drive and are read from the hard disk drive into memory when executed by the CPU. Data during processing is stored in memory, and if necessary, on the HDD. Various functions are realized through the organic collaboration of hardware (such as the CPU and memory), the OS, and necessary application programs. The memory 11 and the memory 21 may, for example, be realized by a memory device. The reaction amount calculator 12, the deviation calculator 13, the model parameter adjuster 14, the hot metal temperature predictor 15, the hot metal temperature determiner 22, and the operation action presentation interface 23 may, for example, be realized by the CPU. The display 30 may, for example, be realized by a display device.

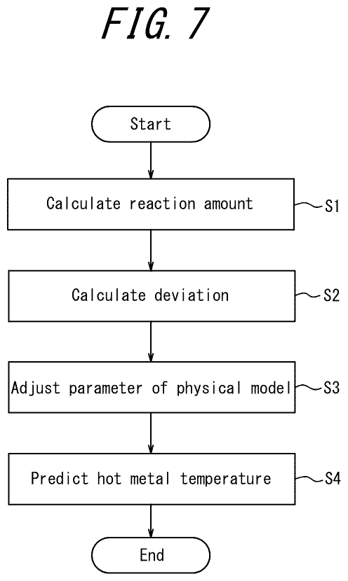

FIG. 7 is a flowchart illustrating a hot metal temperature prediction method according to an embodiment. The hot metal temperature prediction apparatus 10 outputs the predicted hot metal temperature according to the flowchart illustrated in FIG. 7. The hot metal temperature prediction method illustrated in FIG. 7 may be performed as part of a method of manufacturing hot metal.

The reaction amount calculator 12 calculates a reaction amount inside the blast furnace using the physical model (step S1, reaction amount calculation step). The deviation calculator 13 calculates a deviation between the reaction amount calculated using the physical model and a measured reaction amount (step S2, deviation calculation step). The model parameter adjuster 14 adjusts a parameter, of the physical model, that causes drift in a gas inside the blast furnace, so that the deviation is reduced (step S3, model parameter adjustment step). The hot metal temperature predictor 15 then predicts a future hot metal temperature using the physical model for which the parameter was adjusted (step S4, hot metal temperature prediction step).

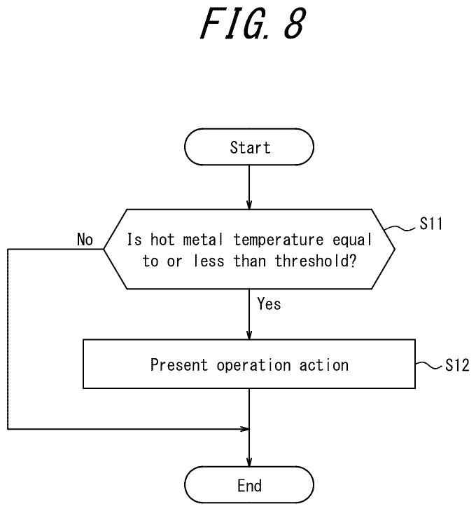

FIG. 8 is a flowchart illustrating an operation guidance method according to an embodiment. The operation guidance apparatus 20 presents an operation action according to the flowchart illustrated in FIG. 8. The operation guidance method illustrated in FIG. 8 may be performed as part of a method of manufacturing hot metal.

In a case in which the hot metal temperature predicted by the hot metal temperature prediction apparatus 10 is equal to or less than a threshold (step S11: Yes), the hot metal temperature determiner 22 causes the operation action presentation interface 23 to present the operation action. The operation action presentation interface 23 presents the operation action to increase the hot metal temperature on the display 30 (step S12, operation action presentation step). In a case in which the predicted hot metal temperature is determined by the hot metal temperature determiner 22 to be higher than the threshold (step S11: No), no operation action is presented.

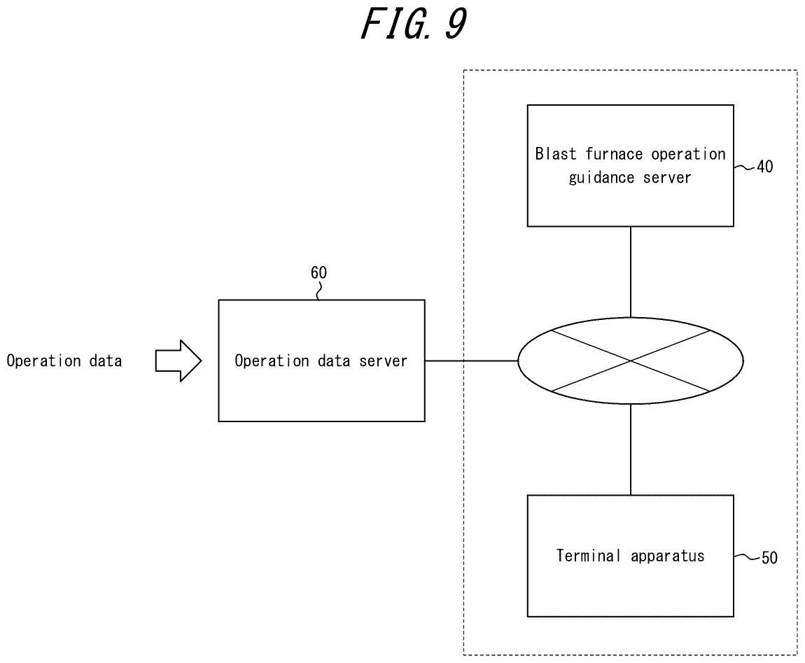

FIG. 9 is a diagram illustrating a configuration of a blast furnace operation guidance system according to an embodiment. The blast furnace operation guidance system may be configured by a blast furnace operation guidance server 40 and a terminal apparatus 50, as illustrated by the dashed lines in FIG. 9, for example. The blast furnace operation guidance server 40 has the functions of the hot metal temperature prediction apparatus 10 and the operation guidance apparatus 20 and may, for example, be realized by a computer. The terminal apparatus 50 functions at least as a display 30 and may, for example, be realized by a portable terminal apparatus, such as a tablet, or a computer. The blast furnace operation guidance server 40 and the terminal apparatus 50 can transmit and receive data to and from each other via a network, such as the Internet. The blast furnace operation guidance server 40 and the terminal apparatus 50 may be in the same location (for example, within the same plant) or may be physically separated. The blast furnace operation guidance system is not limited to the above configuration and may, for example, further include an operation data server 60 that aggregates blast furnace machine operation data (for example, the measured values and operation parameters indicating operation status). The operation data server 60 is capable of communicating with the blast furnace operation guidance server 40 and the terminal apparatus 50 via a network and may, for example, be realized by a computer that manages the manufacturing of hot metal. The operation data server 60 may be in the same location as the blast furnace operation guidance server 40 or the terminal apparatus 50 or may be physically separated. Hereinafter, components and the like will be described using the example of a blast furnace operation guidance system configured to include the blast furnace operation guidance server 40 and the terminal apparatus 50.

The blast furnace operation guidance server 40 acquires the measured values of the blast furnace, performs calculations using the aforementioned physical model, and displays, on the terminal apparatus 50 functioning as a display 30, an operation action as guidance for operating the blast furnace based on the calculated hot metal temperature. The blast furnace operation guidance server 40 includes the components of the hot metal temperature prediction apparatus 10 and the components of the operation guidance apparatus 20 described with reference to FIG. 6. In greater detail, the blast furnace operation guidance server 40 includes a memory, a reaction amount calculator 12, a deviation calculator 13, a model parameter adjuster 14, a hot metal temperature predictor 15, a hot metal temperature determiner 22, and an operation action presentation interface 23. The memory stores a physical model that takes into account reactions and heat transfer phenomena inside the blast furnace, programs and data related to hot metal temperature prediction, programs and data related to operation guidance, and the like. The reaction amount calculator 12, the deviation calculator 13, the model parameter adjuster 14, the hot metal temperature predictor 15, the hot metal temperature determiner 22, and the operation action presentation interface 23 are the same as in the above explanation. The blast furnace operation guidance server 40 may also include a measured value acquisition interface to acquire measured values indicating the operation state of the blast furnace. The measured value acquisition interface may acquire the measured values directly from sensors provided in the blast furnace, from the blast furnace process computer, or the like, or may acquire the measured values via the operation data server 60.

The terminal apparatus 50 forms a blast furnace operation guidance system, together with the blast furnace operation guidance server 40, and displays the operation action. The terminal apparatus 50 includes at least a display 30. The display 30 is the same as in the above explanation. The terminal apparatus 50 may also include an operation action acquisition interface configured to acquire an operation action presented by the blast furnace operation guidance server 40.

As described above, the hot metal temperature prediction method and the hot metal temperature prediction apparatus 10 can, with the aforementioned configuration, predict the hot metal temperature to a high degree of accuracy. The operation guidance method, the method of manufacturing hot metal, the operation guidance apparatus 20, the blast furnace operation guidance system, the blast furnace operation guidance server 40, and the terminal apparatus 50 according to the present disclosure can also provide guidance for the operation of a blast furnace based on a hot metal temperature predicted to a high degree of accuracy. For example, operators can avoid operational problems (such as furnace cooling accidents) by following the operation action presented as guidance.

While embodiments of the present disclosure have been described based on the drawings and examples, it should be noted that various changes and modifications may be made by those skilled in the art based on the present disclosure. Accordingly, such changes and modifications are included within the scope of the present disclosure. For example, the functions and the like included in each component, step, or the like can be rearranged in a logically consistent manner. Components, steps, or the like may also be combined into one or divided. An embodiment of the present disclosure may also be implemented as a program executed by a processor provided in an apparatus or as a storage medium with the program recorded thereon. These are also encompassed within the scope of the present disclosure.

The configurations of the hot metal temperature prediction apparatus 10 and the operation guidance apparatus 20 illustrated in FIG. 6 are only examples. The hot metal temperature prediction apparatus 10 and the operation guidance apparatus 20 need not include all of the components illustrated in FIG. 6. The hot metal temperature prediction apparatus 10 and the operation guidance apparatus 20 may include components other than those illustrated in FIG. 6. For example, the operation guidance apparatus 20 may further include the display 30.

### REFERENCE SIGNS LIST

10 Hot metal temperature prediction apparatus
11 Memory
12 Reaction amount calculator
13 Deviation calculator
14 Model parameter adjuster
15 Hot metal temperature predictor
20 Operation guidance apparatus
21 Memory
22 Hot metal temperature determiner
23 Operation action presentation interface
30 Display
40 Blast furnace operation guidance server
50 Terminal apparatus
60 Operation data server

1. A hot metal temperature prediction method comprising:
calculating a reaction amount inside a blast furnace using a physical model that takes into account reactions and heat transfer phenomena inside the blast furnace;
calculating a deviation between the reaction amount calculated using the physical model and a measured reaction amount;
adjusting a parameter of the physical model that causes drift in a gas inside the blast furnace, so that the calculated deviation is reduced; and
predicting a future hot metal temperature using the physical model for which the parameter was adjusted.

2. The hot metal temperature prediction method according to claim 1, wherein the reaction amount includes at least one of a solution loss carbon amount and a gas utilization ratio.

3. The hot metal temperature prediction method according to claim 1, wherein the parameter is at least one of void ratio and grain size in a specific region within a packed layer inside the blast furnace.

4. An operation guidance method comprising presenting an operation action to increase the hot metal temperature based on the hot metal temperature predicted by the hot metal temperature prediction method according to claim 1.

5. A method of manufacturing hot metal, the method comprising manufacturing hot metal in accordance with the operation action presented by the operation guidance method according to claim 4.

6. A hot metal temperature prediction apparatus comprising:
a memory configured to store a physical model that takes into account reactions and heat transfer phenomena inside a blast furnace;
a reaction amount calculator configured to calculate a reaction amount inside the blast furnace using the physical model;
a deviation calculator configured to calculate a deviation between the reaction amount calculated using the physical model and a measured reaction amount;
a model parameter adjuster configured to adjust a parameter of the physical model that causes drift in a gas inside the blast furnace, so that the calculated deviation is reduced; and
a hot metal temperature predictor configured to predict a future hot metal temperature using the physical model for which the parameter was adjusted.

7. An operation guidance apparatus comprising an operation action presentation interface configured to present an operation action to increase the hot metal temperature based on the hot metal temperature predicted by the hot metal temperature prediction apparatus according to claim 6.

8. The operation guidance apparatus according to claim 7, wherein the operation action presentation interface is configured to present the operation action in a case in which the predicted hot metal temperature is equal to or less than a threshold.

9. A blast furnace operation guidance system comprising:
a blast furnace operation guidance server and a terminal apparatus, wherein
the blast furnace operation guidance server comprises
a measured value acquisition interface configured to acquire a measured value indicating an operation state of a blast furnace,
a memory configured to store a physical model that takes into account reactions and heat transfer phenomena inside the blast furnace,
a reaction amount calculator configured to calculate a reaction amount inside the blast furnace using the physical model,
a deviation calculator configured to calculate a deviation between the reaction amount calculated using the physical model and a measured reaction amount,
a model parameter adjuster configured to adjust a parameter of the physical model that causes drift in a gas inside the blast furnace, so that the calculated deviation is reduced,
a hot metal temperature predictor configured to predict a future hot metal temperature using the physical model for which the parameter was adjusted, and
an operation action presentation interface configured to present an operation action to increase the hot metal temperature based on the predicted hot metal temperature, and
the terminal apparatus comprises
an operation action acquisition interface configured to acquire the operation action presented by the blast furnace operation guidance server, and
a display configured to display the acquired operation action.

10. (canceled)

11. A terminal apparatus forming part of a blast furnace operation guidance system together with a blast furnace operation guidance server, the terminal apparatus comprising:
an operation action acquisition interface configured to acquire an operation action presented by the blast furnace operation guidance server; and
a display configured to display the acquired operation action, wherein
the blast furnace operation guidance server is configured to adjust a parameter, of a physical model that takes into account reactions and heat transfer phenomena inside a blast furnace, that causes drift in a gas inside the blast furnace, so that a deviation between a reaction amount inside the blast furnace calculated using the physical model and a measured reaction amount is reduced, and
the operation action is an operation action to increase a hot metal temperature based on a future hot metal temperature predicted using the physical model for which the parameter was adjusted.
